(19) United States
(12) Patent Application Publication
(10) Pub. No.: US 2010/0317374 A1
(43) Pub. Date: Dec. 16, 2010

(54) APPARATUS FOR AND METHOD OF MANAGING PAGING INTERVAL ACCESS ON A MOBILE STATION

(76) Inventors: Yaron Alpert, Hod Hasharon (IL); Jonathan Segev, Tel Mond (IL)

Correspondence Address: Zaretsky Patent Group PC;Zaretsky Patent Group PC, 13181 NW 11 CT, Sunrise, FL, 33323-3909, US

(21) Appl. No.: 12/482,613

(22) Filed: Jun. 11, 2009

(51) Int. Cl. H04W 68/00

(52) U.S. Cl. 455/458

(57) ABSTRACT

A novel and useful apparatus for and method of managing paging availability of a mobile station in a wireless communications network. The paging availability mechanism of the present invention is able to achieve a substantial amount of power saving by modifying mobile station access to paging intervals. The mechanism dynamically controls access to the wireless network after unavailability periods when mobile stations enter into idle mode. Paging listening intervals for one or more mobile stations are scheduled and synchronized in accordance with the values of one or more parameters or metrics such as link quality. In one embodiment, this is achieved by the mobile station modifying the paging listening intervals access pattern received from the base station. Depending on the one or more parameters or metrics, one or more paging intervals may be skipped thus reducing the power consumption of the mobile station.

### FIELD OF THE INVENTION

The present invention relates generally to wireless communication systems and more particularly relates to an apparatus for and method of managing paging access availability on a mobile station resulting in reduced power consumption.

### BACKGROUND OF THE INVENTION

Wireless networks are used to provide wireless connectivity to mobile terminals, which can also referred to as mobile stations (MS), user equipment (UE), mobile units, etc. Examples of mobile station devices include cellular telephones, personal data assistants (PDA), smart phones, text messaging devices, laptop computers, desktop computers, etc. A typical wireless network includes one or more base stations (BS) that provide wireless connectivity to one or more mobile stations in a particular geographic area or cell. Base stations are also commonly referred to as access points or node-Bs.

A block diagram illustrating an example prior art wireless communications network is shown in FIG. 1. The wireless network, generally referenced 10, comprises a plurality of base stations 12, a plurality of mobile stations 14, access network 16, backhaul network 18, core public switched telephone network (PSTN) 20 and core data network 22. Note that connectivity network may be coupled to a common public or private network such as the Internet 22, a telephone network, e.g., public switched telephone network (PSTN) 20, a local area network (LAN), wide area network (WAN), metropolitan area network (MAN),a cable network, and/or any other wired or wireless network via connection to Ethernet, digital subscriber line (DSL), telephone line, coaxial cable, and/or any wired or wireless connection, etc.

The mobile stations 14 are operative to use any of a variety of modulation techniques such as spread spectrum modulation, single carrier modulation or Orthogonal Frequency Division Modulation (OFDM), etc., and multiple access techniques such as Direct Sequence Code Division Multiple Access (DS-CDMA), Frequency Hopping Code Division Multiple Access (FH-CDMA)), Time-Division Multiple Access (TDMA), Frequency-Division Multiple Access (FDMA), Orthogonal Frequency Division Multiple Access (OFDMA), and/or other suitable modulation techniques to communicate via wireless links.

The base stations maintain communication links with the mobile stations while the access network provides communications between base stations. The access network also provides communications to the connectivity network which links mobile users to the PSTN, Internet/WAN and other external networks. Note that although mobile stations maintain an active connection with one base station, i.e. the serving base station (SBS), they may be within transmission and reception range of multiple base stations, i.e. possible target base stations (TBS).

The mobile station in fixed wireless networks are assumed to have access to an electrical power source, e.g., via a power cord connected to a wall socket or power strip connected to the mains (i.e. electric utility). Due to their access to a readily available power source, fixed wireless network standards typically do not provide features intended to extend battery life. One reason for this is because the lifetime of the battery in the mobile station of a fixed wireless network is not considered a limiting factor for the operation of the mobile station.

In contrast, however, conserving battery power is a very critical issue for mobile stations such as cellular phones, personal data assistants, smart phones, text messaging devices, etc. Consequently, fixed wireless network standards (such as IEEE 802.11 or 802.16-2004) do not provide sufficient power reduction support for mobile stations. In particular, the IEEE 802.11 or 802.16-2004 standards lack a paging signal that may be used to wake a sleeping mobile station. In addition, fixed wireless network standards lack crucial support for sleeping and/or waking mode operations that may be used to conserve battery power in mobile subscriber stations.

Further, as semiconductor manufacturing advances, communication device manufacturers are integrating more and more radios into the same communications device or onto the same integrated circuit. Having multiple radios in a single device provides benefits and advantages to users by enabling the operation of several radios simultaneously. For example, a user may be listening to an FM radio station over a Bluetooth headset while using the GPS radio to navigate to a destination and communicate over a wireless link. Considering the various subsystems that are active in this case, power reduction support is critical.

One of the key aspects affecting the user experience in mobile devices, especially those with multiple radios, is battery life. Advanced radio access communication systems support state of the art Sleep and Idle modes to enable power-efficient mobile station (MS) operation. Sleep and Idle modes are operation methodologies in which an MS pre-negotiates inactivity periods with the Serving Base Station (SBS). These periods are characterized by the unavailability of the MS to the SBS for downlink (DL) traffic, uplink (UL) traffic or both. In general, Idle mode is typically used when a long unavailability period is required or when Sleep mode functionality is absent. Currently, Sleep and Idle modes are used for the minimization of MS power consumption as well as the consumption of the SBS air interface resource. It is noted that each radio access technology has its own specific terms and mechanism for the Sleep and Idle mode functionality.

There is currently great interest in improving mobile communications devices that take advantage of these various wireless modern mobile network technologies. In fact, this interest is almost as great as the interest in improving the underlying technologies themselves. More specifically, power management (or power conservation) techniques that extend or prolong the life of the batteries used in mobile stations has been one area of intense interest.

As mentioned supra, one common technique used in cellular technologies is idle mode, which involves the use of paging techniques. Paging techniques are often used to notify a mobile station, such as a cellular telephone or other type of wireless terminal, that an incoming request to communicate is pending for the mobile station. The use of such a paging technique allows the mobile device to be in a low-power mode, often referred to as “idle mode” or “sleep mode”, at all times except for its assigned listening allocations periods for receiving paging notifications (i.e. paging messages). During a listening allocation period, the mobile station activates its receiver, receives any paging or idle messages, and processes them and if no call is pending, turns off its receiver and goes to “sleep” (reducing his power consumption} until the next assigned listening allocation period. Thus, the mobile device need only remain active long enough to listen to its assigned allocation that was previously defined before returning to the idle mode.

Mobile stations monitor paging messages transmitted over the air link from the base station (i.e. central paging stations) and receive those messages containing recognizable address codes and wake-up instructions. Since mobile stations consume power while they are active, mobile stations that are active all the time quickly drain their batteries. The result is frequent battery replacement or recharging, which can be both inconvenient and costly.

Although the feature of monitoring paging messages conserves some power in these mobile stations, valuable power is still consumed. The mobile stations uniformly become active during their respective wake-up intervals throughout the day according to a “wake-up pattern” or “paging listening interval access pattern” determined by the base station. The base station determines the wake-up interval pattern as a function of a mobile station's worse-case scenario (i.e. the MS with the worst link condition, probably located at the coverage border of the BS, determined using radio planning tools and verified using recorded measurements). Once determined, it is not updated often and may remain configured in the mobile station for relatively long periods of time. It is noted that the majority of the time, the mobile station operates at other than worst-case conditions.

There is thus a need for a mechanism that is able to manage the paging access availability of mobile stations. The mechanism preferably provides an efficient implementation of idle mode operation that is capable of reducing (i.e. optimizing) the rate of battery power consumption of a mobile device while meeting paging availability (service re-establishment), preserving adequate link quality and maintaining service availability requirements.

### SUMMARY OF THE INVENTION

Accordingly, the present invention provides a novel and useful apparatus for and method of managing paging availability of a mobile station in a wireless communications network and in particular in cellular communications networks. The paging access availability mechanism of the present invention is able to increase the operation efficiency of the device and achieve a substantial amount of power saving by modifying mobile station access to paging listening intervals. The invention is particularly applicable to many modern wireless communication systems such as WiMAX, WLAN, GSM, GPRS, EDGE, UWB, wUSB, Bluetooth, 3GPP (UMTS, WCDMA, HSPA, HSUPA, HSDPA, LTE), 3GPP2 (CDMA2000, EVDO, EVDV), DVB and others based broadband wireless access technology, as the mechanism of the invention greatly contributes to supporting and managing the operation of wireless electronics devices throughout the wireless communication system.

In operation, the mechanism dynamically controls access to the wireless network after unavailability periods when mobile stations enter into idle mode. Paging listening intervals for one or more mobile stations are scheduled and synchronized in accordance with the values of one or more parameters or metrics such as link quality and or service availability. In one embodiment, this is achieved by the mobile station modifying its paging listening interval access pattern received from the base station (without notification or negotiation with the BS). For example, depending on the one or more parameters, measurements, assessments or metrics, one or more paging listening intervals may be skipped thus reducing the power consumption of the mobile station.

To aid in illustrating the principles of the present invention, an example mobile station is described. As an example, the mobile station may comprise any suitable wireless standard (i.e. RAT) wherein mobile stations enter idle mode between active paging intervals during which the device wakes up to check for paging messages. Examples of such standard include, but not limited to, GSM, GPRS, EDGE, WiMAX, UWB, wUSB, Bluetooth, WLAN, 3GPP (UMTS, WCDMA, HSPA, HSUPA, HSDPA, LTE), 3GPP2 (CDMA2000, EVDO, EVDV), DVB and others. Note that the invention is not intended to be limited by the type of radio access communication device in the mobile station.

The paging access availability mechanism of the present invention provides several advantages and benefits, including: (1) significant reduction is power consumption while the mobile station is in idle mode; (2) the ability to reduce power consumption in a mobile station without requiring any modifications to base stations and radio access communications systems; (3) the flexibility to process paging listening intervals modifications received from the base station, other external source or generated internally on the mobile station; (4) the flexibility to modify the paging listening interval based on any desired parameter, measurements, assessments, e.g., link quality related parameters, service availability requirements, etc. and (5) no need for negotiation or notification of the MS to the BS or wireless network.

Many aspects of the invention described herein may be constructed as software objects that execute in embedded devices as firmware, software objects that execute as part of a software application on either an embedded or non-embedded computer system running a real-time operating system such as Windows mobile, WinCE, Symbian, OSE, Embedded LINUX, Android, etc., or non-real time operating systems such as Windows, UNIX, LINUX, Android, etc., or as soft core realized HDL circuits embodied in an Application Specific Integrated Circuit (ASIC), Field Programmable Gate Array (FPGA) or Digital Signal Processing (DSP), or as functionally equivalent discrete hardware components.

There is thus provided in accordance with the invention, a method of paging access availability management in a mobile station, the method comprising the steps of determining a current operating condition of the mobile station and determining a dynamic wake-up interval access pattern based on the current operating condition.

There is also provided in accordance with the invention, a method of paging access availability management in a mobile station, the method comprising the steps of receiving an idle configuration from a base station and determining a paging listening intervals access pattern therefrom, determining a current operating environment of the mobile station and skipping one or more wake-up intervals of the paging listening intervals access pattern based on the current operating environment.

There is further provided in accordance with the invention, a mobile station comprising a receiver operative to receive paging messages, an idle processor operative to process the paging messages and determine a paging listening intervals access pattern therefrom, a link condition monitor operative to determine one or more link quality measurements and a wake-up interval module operative to modify the paging listening intervals access pattern based on the one or more link quality measurements.

There is also provided in accordance with the invention, a mobile station comprising a receiver operative to receive paging messages over a paging channel, an idle module operative to process the paging messages, identify a wake-up interval page configuration and update a wake-up interval table, a link condition monitor operative to determine current link conditions and a wake-up module operative to determine a paging listening intervals access pattern using the wake-up interval table whereby the receiver skips one or more wake-up intervals based on the current link conditions.

There is further provided in accordance with the invention, a computer readable storage medium having computer readable program code stored therein for execution by a processor to perform paging access availability management on a mobile station, the computer readable program code comprising computer readable program code that processes received paging messages, identifies a wake-up interval page configuration and updates a wake-up interval table, computer readable program code that determines current wireless link conditions, computer readable program code that determines a paging listening intervals access pattern utilizing the wake-up interval table whereby one or more wake-up intervals is skipped based on the current link conditions.

### BRIEF DESCRIPTION OF THE DRAWINGS

The invention is herein described, by way of example only, with reference to the accompanying drawings, wherein:

FIG. 1 is a block diagram illustrating an example prior art wireless communications network;

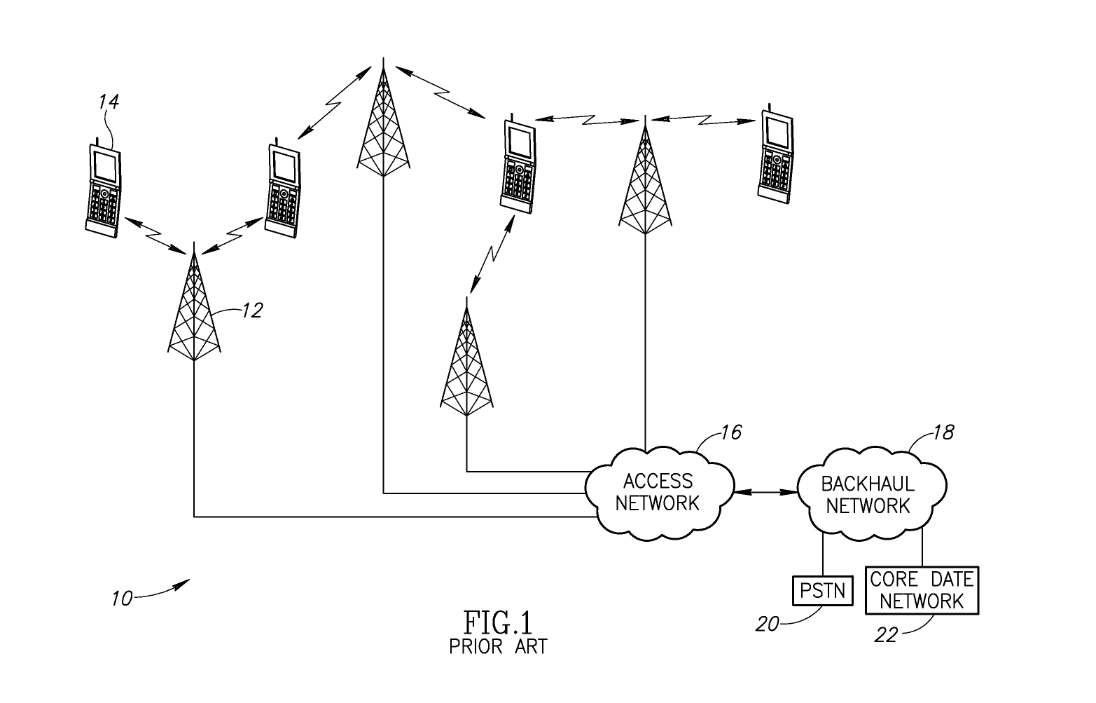

FIG. 2 is a block diagram illustrating a base station in communication with a mobile station incorporating the paging access availability mechanism of the present invention;

FIG. 3 is a block diagram illustrating an example mobile station incorporating the paging access availability mechanism of the present invention in more detail;

FIG. 4 is a diagram illustrating the structure of an idle mode paging cycle;

FIG. 5 is a diagram illustrating an example paging cycle showing skipped wake-up intervals in accordance with an embodiment of the present invention;

FIG. 6 is a block diagram illustrating an example mobile station incorporating the paging access availability mechanism of the present invention;

FIG. 7 is a diagram illustrating an example WUID module link parameter update mechanism;

FIG. 8 is a diagram illustrating an example mechanism for wake-up interval access pattern selection;

FIG. 9 is a flow diagram illustrating the paging access availability method of the present invention;

FIG. 10 is a flow diagram illustrating the wake-up interval determination method of the present invention; and

FIG. 11 is a block diagram illustrating an example computer processing system adapted to implement the paging access availability mechanism of the present invention.

### DETAILED DESCRIPTION OF THE INVENTION

### Notation Used Throughout

The following notation is used throughout this document.

| Term | Definition |
|---|---|
| 3GPP | Third Generation Partnership Project |
| AC | Alternating Current |
| ASIC | Application Specific Integrated Circuit |
| AVI | Audio Video Interleave |
| BER | Bit Error Rate |
| BLER | Block Error |
| BMP | Bitmap |
| BS | Base Station |
| BWA | Broadband Wireless Access |
| CDMA | Code Division Multiple Access |
| CD-ROM | Compact Disc-Read Only Memory |
| CINR | Carrier to Interferences and Noise Ratio |
| CIR | Committed Information Rate |
| CPU | Central Processing Unit |
| CQI | Channel Quality Indicators |
| CS | Circuit Switched |
| DC | Direct Current |
| DL | Downlink |
| DL-MAP | Downlink Medium Access Protocol |
| DS-CDMA | Direct Sequence Code Division Multiple Access |
| DSL | Digital Subscriber Loop |
| DSP | Digital Signal Processing |
| DVB | Digital Video Broadcast |
| EDGE | Enhanced Data rates for GSM Evolution |
| EEPROM | Electrically Erasable Programmable Read Only Memory |
| EEROM | Electrically Erasable Read Only Memory |
| EPROM | Electrically Programmable Read Only Memory |
| EVDO | Evolution-Data Optimized |
| FDMA | Frequency Division Multiple Access |
| FEM | Front End Module |
| FH | Frequency Hopping |
| FM | Frequency Modulation |
| FPGA | Field Programmable Gate Array |
| FTP | File Transfer Protocol |
| GPRS | General Packet Radio Service |
| GPS | Global Positioning Satellite |
| GSM | Global System for Mobile Communication |
| HDL | Hardware Description Language |
| HSDPA | High-Speed Downlink Packet Access |
| HSPA | High Speed Packet Access |
| HSUPA | High-Speed Uplink Packet Access |
| HTTP | Hyper Test Transfer Protocol |
| IEEE | Institute of Electrical and Electronic Engineers |
| JPG | Joint Photographic Experts Group |
| KPI | Key Performance Indicators |
| LAN | Local Area Network |
| LTE | Long Term Evolution |
| LUT | Look Up Table |
| MAC | Media Access Control |
| MAN | Metropolitan Area Network |
| MP3 | MPEG-1 Audio Layer 3 |
| MPG | Moving Picture Experts Group |
| MS | Mobile Station |
| MS | Mobile Station |
| NIC | Network Interface Card |
| OFDM | Orthogonal Frequency Division Modulation |
| OFDM | Orthogonal Frequency Division Modulation |
| OFDMA | Orthogonal Frequency Division Multiple Access |
| PC | Personal Computer |
| PCI | Peripheral Component Interconnect |
| PDA | Personal Digital Assistant |
| PDSN | Packet Data Serving Node |
| PNA | Personal Navigation Assistant |
| PND | Personal Navigation Device |
| PRBS | Pseudo Random Binary Sequence |
| PROM | Programmable Read Only Memory |
| PSTN | Public Switched Telephone Network |
| QoS | Quality of Service |
| RACD | Radio Access Communications Device |
| RAM | Random Access Memory |
| RAN | Radio Access Network |
| RAT | Radio Access Technology |
| RF | Radio Frequency |
| RNC | Radio Network Controller |
| ROM | Read Only Memory |
| RSS | Received Signal Strength |
| RTD | Round Trip Delay |
| SAN | Storage Area Network |
| SBS | Serving Base Station |
| SDIO | Secure Digital Input/Output |
| SIM | Subscriber Identity Module |
| SIP | Session Initiation Protocol |
| SNR | Signal to Noise Ratio |
| SPI | Serial Peripheral Interface |
| STC | Space Time Code |
| TDMA | Time Division Multiple Access |
| UE | User Equipment |
| UL | Uplink |
| UMTS | Universal Mobile Telecommunications System |
| USB | Universal Serial Bus |
| UWB | Ultra Wideband |
| WCDMA | Wideband Code Division Multiple Access |
| WiFi | Wireless Fidelity |
| WiMAX | Worldwide Interoperability for Microwave Access |
| WLAN | Wireless Local Area Network |
| WLL | Wireless Local Loop |
| WMA | Windows Media Audio |
| WMV | Windows Media Video |
| WUID | Wake-Up Interval Determination |
| wUSB | Wireless USB |
| WWAN | Wireless Wide Area Network |

### DETAILED DESCRIPTION OF THE INVENTION

Accordingly, the present invention provides a novel and useful apparatus for and method of managing paging availability of a mobile station in a wireless communications network and in particular in cellular communications networks. The paging access availability mechanism of the present invention is able to increase the operation efficiency of the device and achieve a substantial amount of power saving by modifying mobile station access to paging listening intervals. The invention is particularly applicable to numerous modern wireless communication systems such as WiMAX, WLAN, GSM, GPRS, EDGE, UWB, wUSB, Bluetooth, 3GPP (UMTS, WCDMA, HSPA, HSUPA, HSDPA, LTE), 3GPP2 (CDMA2000, EVDO, EVDV), DVB and others based broadband wireless access technology, as the mechanism of the invention greatly contributes to supporting and managing the operation of wireless electronics devices throughout the wireless communication system.

To aid in illustrating the principles of the present invention, an example mobile station is described. As an example, the mobile station may comprise any suitable wireless standard (i.e. RAT) wherein mobile stations enter idle mode between active paging intervals during which the device wakes up to check for paging messages. Examples of such standard include, but not limited to, GSM, GPRS, EDGE, WiMAX, UWB, wUSB, Bluetooth, WLAN, 3GPP (UMTS, WCDMA, HSPA, HSUPA, HSDPA, LTE), 3GPP2 (CDMA2000, EVDO, EVDV), DVB and others. Note that the invention is not intended to be limited by the type of radio access communication device in the mobile station.

Note that throughout this document, the term communications transceiver or device is defined as any apparatus or mechanism adapted to transmit, receive or transmit and receive information through a medium. The communications device or communications transceiver may be adapted to communicate over any suitable medium, including wireless or wired media. Examples of wireless media include RF, infrared, optical, microwave, UWB, Bluetooth, WiMAX, GSM, EDGE, UMTS, WCDMA, LTE, CDMA-2000, EVDO, EVDV, WiFi, or any other broadband medium, radio access technology (RAT), etc.

The term mobile station is defined as all user equipment and software needed for communication with a network such as a RAN and capable of wireless telephony and/or data communications. Examples include a system, cellular telephone, subscriber unit, mobile unit, mobile device, mobile, remote station, remote terminal, access terminal, user terminal, user agent, user equipment, etc. The term mobile station is also used to denote other devices including, but not limited to, a multimedia player, mobile communication device, node in a broadband wireless access (BWA) network, smartphone, PDA, PND, Bluetooth device, cellular phone, smart-phone, handheld communication device, handheld computing device, satellite radio, global positioning system, laptop, cordless telephone, Session Initiation Protocol (SIP) phone, wireless local loop (WLL) station, handheld device having wireless connection capability or any other processing device connected to a wireless modem. A mobile station normally is intended to be used in motion or while halted at unspecified points but the term as used herein also refers to devices fixed in their location.

The term multimedia player or device is defined as any apparatus having a display screen and user input means that is capable of playing audio (e.g., MP3, WMA, etc.), video (AVI, MPG, WMV, etc.) and/or pictures (JPG, BMP, etc.). The user input means is typically formed of one or more manually operated switches, buttons, wheels or other user input means. Examples of multimedia devices include pocket sized personal digital assistants (PDAs), personal navigation assistants (PNAs), personal navigation devices (PNDs), personal media player/recorders, cellular telephones, handheld devices, and the like.

The term radio access communications device (RACD), radio access communications system or radio access communications transceiver is defined as any apparatus, device, system or mechanism adapted to transmit, receive or transmit and receive data through a medium. The communications device or communications transceiver may be adapted to communicate over any suitable medium, including wireless or wired media.

The word ‘exemplary’ is used herein to mean ‘serving as an example, instance, or illustration.’ Any embodiment described herein as ‘exemplary’ is not necessarily to be construed as preferred or advantageous over other embodiments.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

Note all of the above and terms similar thereto are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices or to a hardware (logic) implementation of such processes.

The invention can take the form of an entirely hardware embodiment, an entirely software embodiment or an embodiment containing a combination of hardware and software elements. In one embodiment, a portion of the mechanism of the invention can be implemented in software, which includes but is not limited to firmware, resident software, object code, assembly code, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (embedded or removable in the form of, e.g., USB flash drive, SDIO module, etc.), ROM, EPROM, or other semiconductor memory devices.

### First Example Mobile Station Incorporating the Paging Access Availability Mechanism

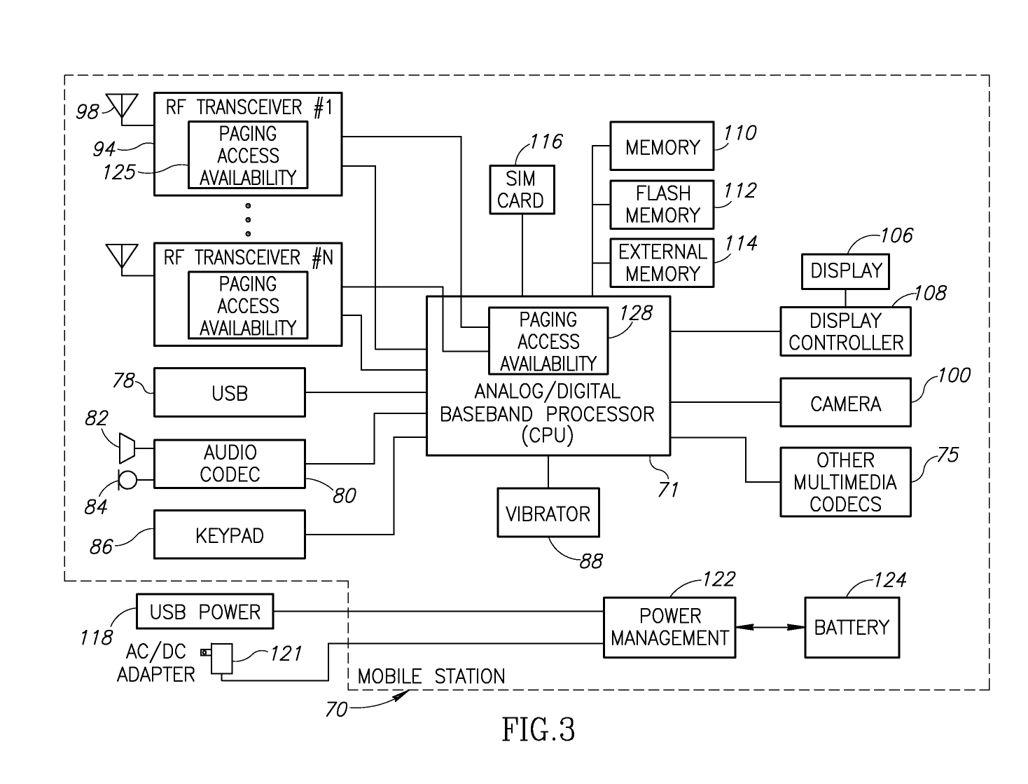

A block diagram illustrating an example mobile station incorporating the paging listening interval access mechanism of the present invention is shown in FIG. 3. Note that the communication device may comprise any suitable wired or wireless device such as mobile station, multimedia player, mobile communication device, cellular phone, smartphone, PDA, PNA, PND, Bluetooth device, etc. For illustration purposes only, the device is shown as a mobile station, such as a cellular phone. Note that this example is not intended to limit the scope of the invention as the coordination mechanism of the present invention can be implemented in a wide variety of communication devices.

The mobile device, generally referenced 70, comprises a processor or CPU 71 having analog and digital baseband portions and an application portion. The mobile device may comprise a plurality of RF transceivers 94 and associated antennas 98. RF transceivers for the basic cellular link and any number of other wireless standards and Radio Access Technologies (RATs) may be included. Examples include, but are not limited to, wireless wide area network (WWAN), cellular technologies such as Global System for Mobile Communication (GSM), General Packet Radio Services (GPRS), Enhanced Data for Global Evolution (EDGE), CDMA, EVDO, EVDV, Wideband Code Division Multiple Access (WCDMA), HSPA, LTE, Universal Mobile Telecommunications System (UMTS); WiMAX for providing WiMAX wireless connectivity when within the range of a WiMAX wireless network; Bluetooth for providing Bluetooth wireless connectivity when within the range of other Bluetooth devices; WLAN for providing wireless connectivity when in a hot spot or within the range of an ad hoc, infrastructure or mesh based wireless LAN network; near field communications; UWB; FM to provide the user the ability to listen to FM broadcasts as well as the ability to transmit audio over an unused FM station at low power, such as for playback over a car or home stereo system having an FM receiver, GPS, TV tuner, etc. One or more of the RF transceivers may comprise additional antennas to provide antenna diversity which yields improved radio performance. The mobile device may also comprise internal RAM and ROM memory 110, Flash memory 112 and external memory 114.

Several user-interface devices include microphone(s) 84, speaker(s) 82 and associated audio codec 80 or other multimedia codecs 75, a keypad or touchpad 86 for entering dialing digits and for other controls and inputs, vibrator 88 for alerting a user, camera and related circuitry 100 and display(s) 106 and associated display controller 108. A USB or other interface connection 78 (e.g., SPI, SDIO, PCI, etc.) provides a serial link to a user's PC or other device. An optional SIM card 116 provides the interface to a user's SIM card for storing user data such as address book entries, user identification, etc.

The RF transceivers 94 also comprise paging access availability manager module/manager/controller 125 constructed in accordance with the present invention. Alternatively, or in addition to, a centralized paging access availability manager module/manager/controller 128 is implemented on the baseband processor 71. The paging access availability manager modules 125, 128 are adapted to implement the paging access availability mechanism of the present invention as described in more detail infra. The paging access availability mechanism of the present invention can be implemented either in a distributed, centralized or hybrid manner. The paging access availability manager 128 facilitates a centralized implementation while paging access availability manager 125 facilitates a distributed implementation. Hybrid implementations apportion implementation of the mechanism between the coordination manager 125 in the RF transceivers 94 and the centralized coordination manager 128. In operation, the paging access availability mechanism may be implemented as hardware, software or as a combination of hardware and software. Implemented as a software task, the program code operative to implement the paging access availability mechanism of the present invention is stored in one or more memories 110, 112 or 114 or local memories within the baseband.

Portable power is provided by the battery 124 coupled to power management circuitry 122. External power is provided via USB power 118 or an AC/DC adapter 121 connected to the battery management circuitry 122, which is operative to manage the charging and discharging of the battery 124.

### Paging Access Availability Management Mechanism

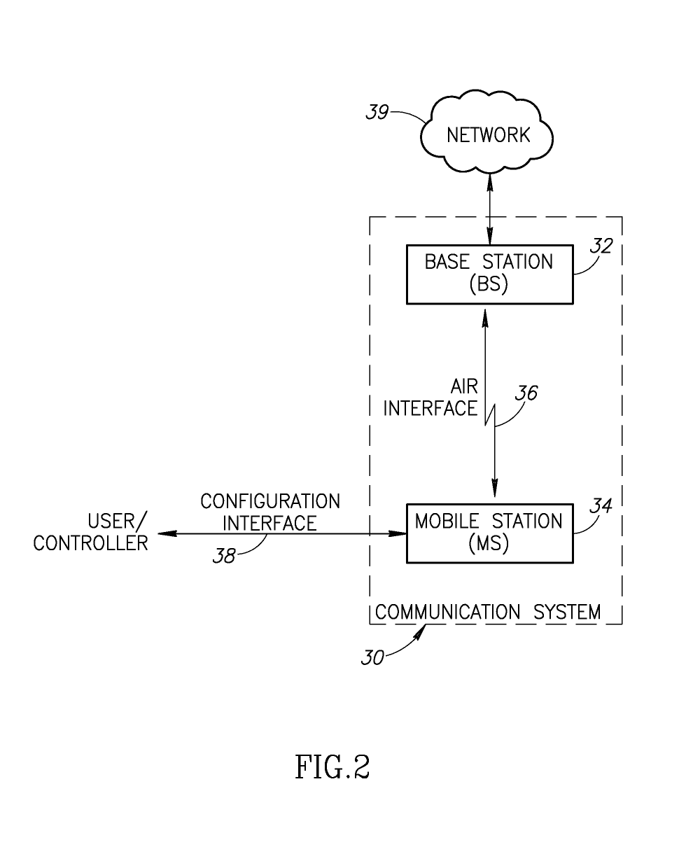

A block diagram illustrating a base station in communication with a mobile station incorporating the paging access availability mechanism of the present invention is shown in FIG. 2. The wireless communication system, generally referenced 30, comprises one or more base stations 32 in communication with network 39 and mobile stations 34. Note that only a single base station and mobile station are shown for clarity.

Each BS 32 is capable of initiating, establishing, maintaining, transmitting, receiving, terminating or performing any other desired action related to a call session with one or more MSs 34. For example, each BS may combine Radio Network Controller (RNC) and Packet Data Serving Node (PDSN) functions in a single entity. The BS may also be configured to communicate with other BSs, devices, networks, etc. in a manner known to persons skilled in the communication arts. In one embodiment, the BS comprises both base station functionality and gateway functionality. Accordingly, the BS and/or gateways described herein may refer to BS and/or gateways (1) implemented as separate entities or (2) implemented in a BS.

The BS provides wireless telecommunication links 36 to the MSs within an associated geographic region, referred to hereinafter as a cell. The MS communicates with the BS over the air interface 36. The wireless communication system 30 comprises one or more MSs, which may be fixed or mobile, may comprise cellular telephones, personal data assistants, smart phones, text messaging devices, handheld scanners, laptop computers, desktop computers, etc.

The example MS shown herein does not have continuous access to an external power supply (i.e. mains power). Most cellular telephones incorporate batteries that supply power while in use. In addition, non-mobile (i.e. fixed) devices also use batteries for backup in case of power failure or unexpected shutdown. Cellular telephones are connected temporarily to power sources to recharge their batteries but typically remain disconnected for long periods relative to the expected life of the battery.

At least in part to conserve battery power, the MS enters the idle state. The term ‘idle state” is intended to refer to terminating and/or holding processes executing on the MS that are not necessary to sustain a connection over the air interface 36. For example, when the MS is in idle, the MS runs a small number of processes that occasionally “listen” to one or more paging listening interval access patterns (e.g., paging channels) in order to maintain connectivity over the air interface.

Efficient implementation of idle mode operation is a consideration in all mobile networks including IEEE 802.16 based mobile WiMAX networks. In order to control and deliver wake-up instructions to the MSs, the BS transmits air-interface (or air-link) messages. The MS processes these instructions and becomes available to the BS based on a wake-up pattern determined extracted and/or generated from these messages.

The idle mode is a common technique used in cellular technologies which involves the use of paging techniques. Paging techniques are often used to notify a mobile station, such as a cellular telephone or other type of wireless terminal, that an incoming request to communicate is pending for the mobile station. The use of such a paging technique allows the mobile device to be in a low-power mode, often referred to as “idle mode”, at all times except for its assigned listening interval slot for receiving the paging notification. During its listening interval, the mobile station activates its receiver, receives any paging or idle messages, processes these messages and if no call is pending, turns off its receiver and goes to “sleep” (i.e. inactive) until the next assigned listening interval. Thus, the mobile device need only remain active long enough to listen to its assigned listening interval that was previously defined before returning to the idle mode.

It is noted that the paging mechanism is targeted at limiting the air interface resources allocated to the user which do not participate in the transfer of data signaling or voice data. Thus, paging is a unidirectional signaling from the BS to the MS until the BS has data signaling or voice data to transfer to the MS. Due to this nature of the paging mechanism and due to the mobile nature of the MS, information related to the possible location of the MS and the current downlink (DL) channel condition exists at the BS. Thus, modulation and coding of the paging channel and repetition of the paging signaling itself is used to achieve cell coverage. In practice, the majority of the time the paging channel is coded and repeated more than is required by the MSs covered by the cell. The MS may rely on this and select a reduction of the paging channel (i.e. fewer wake-up intervals) thereby reducing its power consumption.

### Example Idle Mode Paging Cycle

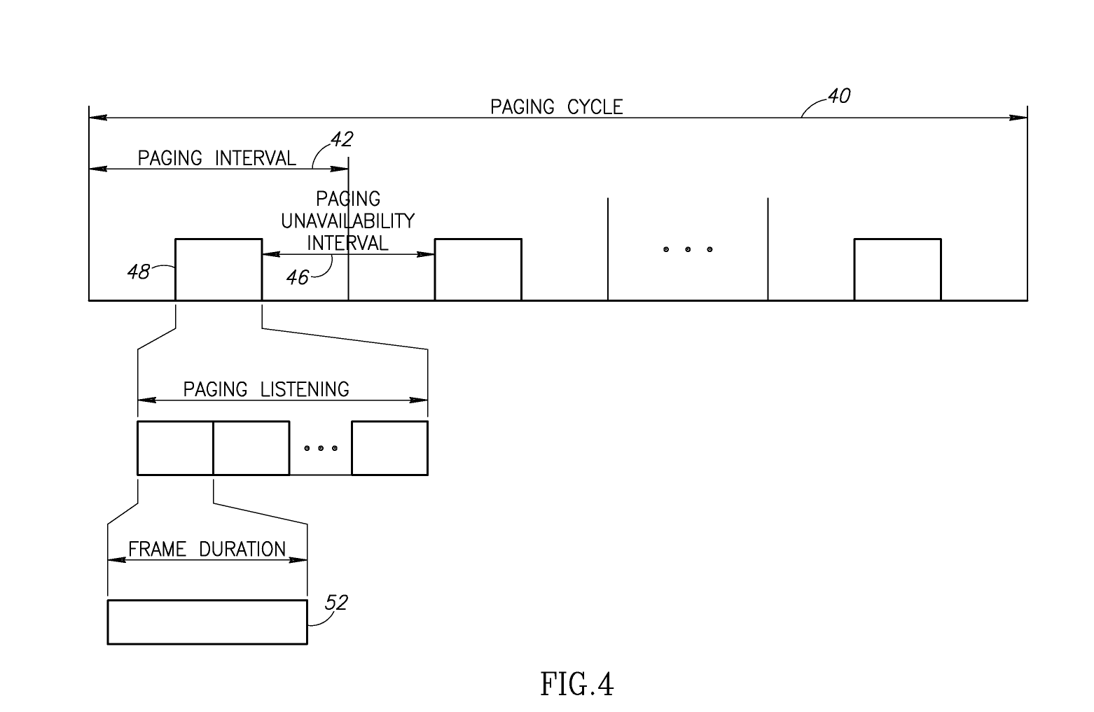

A diagram illustrating the structure of an example idle mode paging cycle is shown in FIG. 4. The wireless communication system preferably operates in accordance with a conventional repeating paging cycle 40 divided into equal paging intervals 42. Each paging interval comprises a paging listening interval (also referred to as wake-up interval) 48. Each paging listening interval comprises a plurality of frames 52. The duration between paging listening intervals is referred as the paging unavailability interval 46.

As an example, consider a paging cycle 40 ten seconds in duration. Each paging interval 42 may be one second with a paging listening interval 48 of 5 frames and unavailability interval of 195 frames (i.e. 5 msec frame duration).

The time interval is called a paging interval and includes one paging listening interval and one paging unavailability interval. A wireless terminal in the idle state operates only during the portion of the listening paging interval. During the paging unavailability interval, the wireless terminal is not performing any processing, in particular processing related to receiving a page message. In order to maximize the benefit of being in the idle state and maintaining adequate service availability, paging schemes generally use a large value for the paging interval and paging cycle. For example, in a voice system (e.g., GSM and CDMA IS-95) the typical paging cycle is approximately 1 to 5 seconds. During this period, the BS may allocate several listening intervals in accordance with the service availability and worst case MS link conditions of the MS and the coverage of the BS. This paging scheme is well suited for establishing end-to-end set-up of conventional communications services such as voice channels which may have a relatively long duration and can support a fair amount of delay, e.g., several seconds, between paging periods.

Although a longer paging cycle helps conserves power, it causes the paging latency to increase, which is not suitable for various emerging services, such as push-to-talk. These emerging services typically require a very short paging latency, e.g., paging cycles well under a few seconds, to give users a sense of an immediate response. During a paging cycle, most of the battery power consumption is caused by the need, each “wake-up” period, to calculate a channel estimate and perform other required receiver related tasks. In systems that require a short paging cycle, e.g., push-to-talk, frequent wake-up operations quickly drain the battery, requiring frequent recharging, which is undesirable from a user perspective.

### Example Paging Cycle With Adaptive Paging Listening Intervals

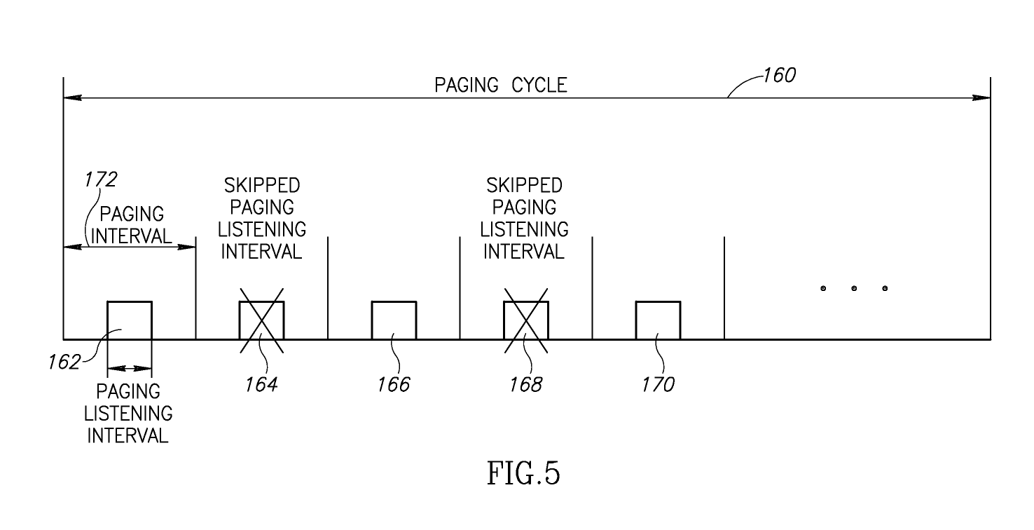

A diagram illustrating an example paging cycle showing skipped paging listening intervals in accordance with an embodiment of the present invention is shown in FIG. 5. As described supra, mobile stations normally monitor the paging messages transmitted over the air link from the base station (i.e. central paging station) and receive those messages containing recognizable address codes and wake-up instructions. Since power consumption in mobile stations is greatest when they are active, mobile stations that are active all the time quickly drain their batteries. The result is frequent battery replacement or recharging, which can be both inconvenient and costly.

Although the technique of monitoring paging messages conserves some power in these mobile stations (versus an always on receiver), valuable power is still consumed. The mobile stations uniformly become active during their respective paging listening intervals throughout the day according to a “wake-up pattern” or “paging listening interval access pattern” determined by the base station. The base station determines the wake-up interval pattern typically as a function of other mobile station's connected to the BS considering a worse-case scenario.

In accordance with conventional techniques, the MS becomes active during specified frames of a repeating paging cycle, referred to as the “paging listening interval” and is inactive or idle during the remaining frames of the paging cycle. During wake-up intervals, the MS reconnects to the BS(s) in the same paging group and receives and decodes designated paging allocations or channels for page messages and receives only those page messages containing recognizable address codes, in accordance with conventional wireless techniques.

The BS transmits wake-up messages several times sequentially until the MS responds, up to one complete paging cycle. If, for example, the MS is at the edge of a cell coverage, in order to attain a minimum service availability (e.g., 99.99%), the wake-up message is repeated one complete paging cycle, i.e. 5 to 10 times (of paging intervals) to ensure reception. The MS may miss one or more wake-up message for any reason such as interference, low SNR, poor link conditions, clock drift, etc. Using the example above, this means that the MS will receive the wake-up messages in 99.99% of the attempts during a complete paging cycle. Missing receiving a wake-up message during a complete paging cycle may mean missing a call which is not desirable. The BS determines the paging cycle access pattern such that the MS will receive the wake-up message within a certain number of wake-up intervals. If one wake-up interval is missed, there is still a chance it will be received on the next wake-up interface up to the complete paging cycle.

The BS calculates the paging cycle, paging intervals and paging listening intervals on a substantially static or slowly updated dynamic manner commonly for all MSs connected to the BS. Thus, the MS operating conditions (i.e. services, link conditions, operating environment, etc. of the MS) between the MS and the BS, which change dynamically over time, are usually superior to the worse case. The present invention takes advantage of the rapidly changing link conditions to dynamically modify the paging listening access pattern. When link conditions improve, for example, one or more listening intervals may be skipped to reduce power consumption. Thus, in this case, only a subset of the original paging cycle access pattern is adhered to.

In accordance with an embodiment of the present invention, the potential listening intervals and the listening intervals access pattern (i.e. the wake-up pattern or paging message reception) that the MS (or other management entity) uses to access the BS is modified. This modification can be achieved in a variety of ways, such as via (1) over-the-air programming 36 (FIG. 2), in which case the MS receives and processes an “idle wake-up interval configuration message”; (2) a configuration interface 38 between the user/controller and the MS; or (3) a process internal to the MS. When such an idle message is received, the MS replaces or modifies the stored paging listening intervals pattern with the new paging listening intervals pattern. In one embodiment of the present invention, the MS is operative to modify or skip at least one wake-up interval based on its current connectivity (link) status.

Referring to FIG. 5, the paging cycle 160 is divided into paging intervals 172, which comprise listening intervals 162, 164, 166, 168, 170. In this example, however, due to the link quality (i.e. environment conditions) between the MS and the BS, every other listening interval is skipped (i.e. listening intervals 164, 168, etc.). Other listening interval patterns may also be implemented depending on several factors including currently measured link quality.

Note that an “idle value” for the MS represents the percentage of time that the MS is in idle within a paging cycle. Thus, for example, in the configuration shown in FIG. 4, the “idle value” or “idle ratio” is equal to 10/200=5%. Applying the paging access availability mechanism of the present invention, however, the MS wakes-up every other paging cycle, in which case its sleep value is 5/200=2.5%, thereby reducing power consumption by 50%, which effectively doubles the battery duration during idle time.

### Second Example Mobile Station Incorporating the Paging Access Availability Mechanism

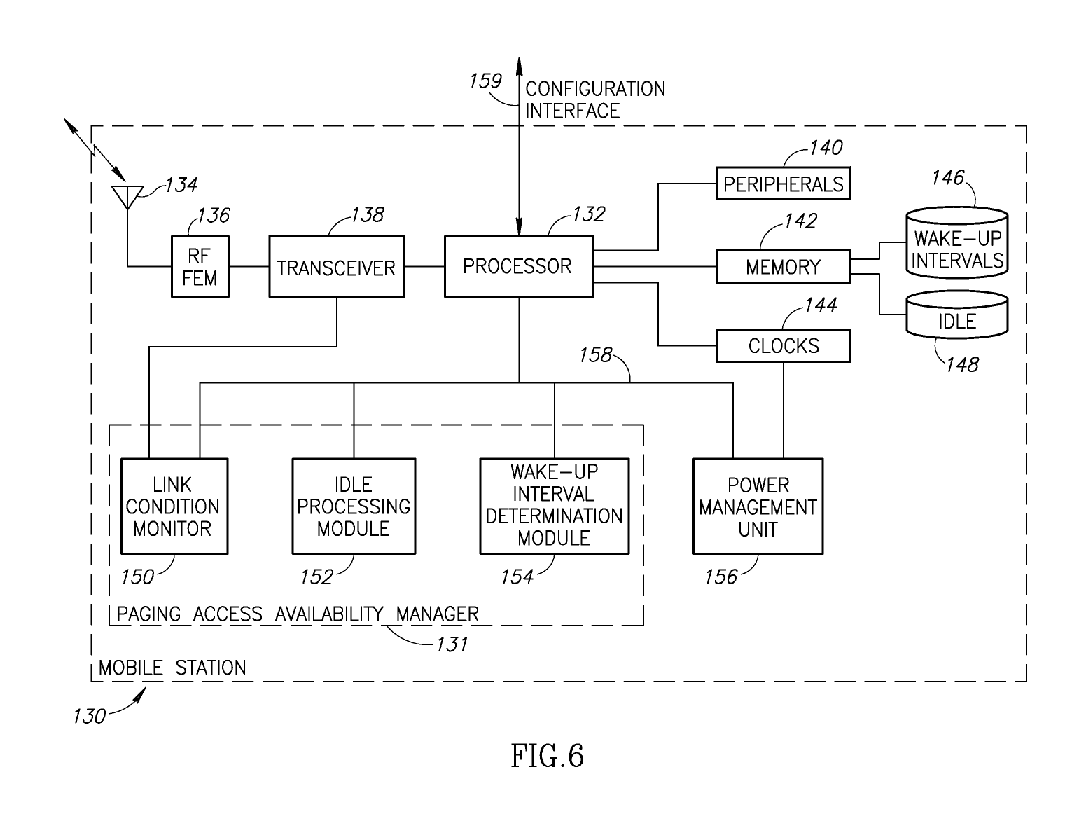

A block diagram illustrating an example mobile station incorporating the paging access availability mechanism of the present invention in more detail is shown in FIG. 6. The example mobile station, generally referenced 130, comprises a processor 132, transceiver 138, RF front end module (FEM) 136, antenna 134, peripherals 140 (keyboard, keypad, display, pointing device, multimedia devices, etc.), memory 142, clocks 144, wake-up interval database 146, idle database 148, paging access availability manager 131 and power management unit 156 coupled to battery 157. The paging access availability manager 131 comprises link condition monitor 150, idle processing module 152, wake-up interval determination module 154. All components and modules within the MS are coupled together via a bus over which the various elements can interchange data and control information. The memory 142 may comprise any suitable memory device such as static or dynamic RAM, nonvolatile memory such as FLASH, EEPROM, EPROM, PROM, ROM or any other type of memory.

The processor and the various functional blocks, modules, circuits, elements and components described in connection with the embodiments disclosed herein may be implemented on a general purpose processor, digital signal processor (DSP), application specific integrated circuit (ASIC), field programmable gate array (FPGA), state machine or other programmable logic component, discrete gate or transistor logic, discrete hardware components, or any combination thereof. A general-purpose processor may be a microprocessor, but in the alternative, the processor may be any conventional processor, controller, microcontroller, or state machine.

In general, the mechanism of the invention comprises (1) receiving from the BS (i.e. managed entity), a wireless link signal that, once processed and analyzed, provides updated information and indications of the current coactivity level and/or that relate to the reception of communications transmitted by the BS; (2) after analyzing the updated information, determining a new paging listening intervals access pattern such as based on predefined access opportunities; (3) controlling the internal modules in the mobile station in accordance with the modified selected paging listening intervals access pattern.

In operation, the processor 132 is operative to establish a network connection with a BS connected to the wireless network. The transceiver 138 is in communication with the processor and is configured to receive and/or transmit messages to the BS to determine if an incoming call request for the MS has been received at the BS.

The processor is also configured to operate the device in an active mode and/or idle mode wherein the processor is configured to communicate with the BS over an air-interface. The memory 142 is adapted to store a selectable idle mode listening intervals access pattern configurable by a user and/or a transceiver. The processor is also configured to detect and monitor the condition and performance of the air-interface link and to determine the connectivity quality level. The memory 142 is adapted to store these results or other processing results which are analyzed and an update to the paging listening intervals access pattern is generated therefrom. Based on the analysis of the results, the MS further comprises a triggering mechanism that may trigger a selectable idle and/or sleep mode paging listening intervals access pattern based on the new results.

According to an embodiment of the invention, the paging listening intervals are scheduled and synchronized for the MSs distributed throughout the wireless communication system. The MSs operate or communicate in accordance with various protocols and standards (e.g., that comply with the IEEE 802.16 series of protocols such as the WiMAX protocol).

In one embodiment, the MS comprises (1) means for receiving idle configuration (paging) messages from the BS which comprise a listening intervals access pattern message comprising a new listening intervals access pattern; means for storing a listening intervals access pattern; (2) means for updating the listening intervals access pattern stored in the wake-up interval database 146 with the new listening intervals access pattern contained in the page message; and (3) means for activating the MS in accordance with the listening intervals access interval pattern stored in the wake-up interval database. The updated listening intervals access pattern message information is analyzed and a selectable idle mode access pattern is selected based thereon.

In another embodiment, the BS is operative to (1) determine a preferred idle value for an MS based upon customer profiles (received in idle message or configured in the MS) and link quality (condition) monitoring; (2) generate and update a listening intervals access pattern in accordance with the preferred idle value; and (3) transmit a listening intervals access pattern page message to the MS. The MS is operative to receive the listening intervals access pattern page message and update a wake-up interval stored in the wake-up interval database with the new wake-up interval selected.

With reference to FIG. 6, the transceiver 138 comprises a receiver and transmitter coupled to an antenna via RF front end module 136. The transceiver receives downlink signals from the BS send over the air-interface to the MS, processes them (i.e. demodulate, decode, etc.), identifies paging messages (i.e. idle messages) containing a recognizable address and forwards the paging messages to the idle processing module 152 or stores (buffers) them in memory 142. Alternatively, “idle wake-up interval configuration” messages are received over the configuration interface 159.

The idle processing module 152 receives page messages received by the transceiver or previously stored (buffered) in memory 142, processes and analyzes these messages (i.e. during wake-up intervals) and identifies a “wake-up interval page configuration”. In response, the idle processing module updates one or more idle profiles (as described infra), the wake-up interval table 146 and the idle information database 148 stored in memory and sends notifications to the wake-up interval determination module 154 if the BS requests to change the paging intervals access pattern. Alternatively, the wake-up interval can be updated based on decisions generated by the wake-up interval determination module 154.

The memory 142 is adapted to store program code data (applications, routines, tasks, etc.) for execution on the processor 132 and data/information. The memory also stores the MS profile and configuration information including QoS provisioned and active profiles, air interface (link quality) condition information provided by the link condition monitor module 150 and actual wake-up interval and sleep values determined by the wake-up interval determination module 154.

The processor 132, comprising a CPU, microprocessor, FPGA, ASIC or DSP core, etc. is operative to (1) execute the program code data stored in memory 142 and utilize the data/information to control the various MS modules (150, 152, 154, 156), (2) to perform routine wireless terminal operations, including, for example, receive downlink traffic channel information, transmit uplink traffic channel information, perform power control operations, perform timing control operations, and (3) implement the paging access availability management mechanism of the present invention.

In addition, the processor is in communication with the link condition monitor 150 and initiates program code routines for performing link condition monitoring using a number of PHY level and MAC level indicators. The link condition monitor initiates PHY level and MAC level transmission and reception program routines. The link condition monitor is operative to monitor the condition of the air-interface link and provides an indication about the connectivity level (i.e. link and communication quality) to other MS devices. For example, link condition monitor is operative to analyze link conditions during the listening interval and based on predefined thresholds, a link quality indicator or other appropriate notification is sent to the wake-up interval determination module 154.

The wake-up interval determination module 154 is operative to analyze the changes in the link conditions or service availability requirements, define a new modified paging intervals access pattern and send it to the paging power management unit 156. The power management unit 156 is operative to implement the new functionality upon receipt of the modified pattern.

The following are examples of measurements that may be controlled by the link condition monitor 150 (FIG. 6) and may be used as the basis for the paging access availability management mechanism. The measurements types presented below are divided into six groups, but as will be appreciated by those skilled in the art, not all of these categories or all of the measurements must be used to derive successful algorithms. Further, any number of parameters within each set may be used and in any combination.

Briefly, the link quality comprises information that relates to at least one of the following parameters groups: Group 1 comprising parameters whose values are derived from intra-frequency measurements carried on the wireless link; Group 2 comprising parameters whose values are derived from inter-frequency measurements carried on links other than the current wireless link; Group 3 comprising parameters whose values are derived from inter-system measurements; Group 4 comprising parameters that relate to the managed entity's positioning measurements; Group 5 comprising parameters that relate to measurements of traffic volume; and Group 6 comprising parameters that relate to results of the wireless link quality measurements. A more detailed list of the link quality parameters in each of the six groups is provided hereinbelow.

Group 1 comprises parameters whose values are derived from intra-frequency measurements carried out by intra-frequency measuring means on the estimated channel that extends between the BS and the corresponding MS. Optional parameters include: Channel Quality Indicators (CQI), Carrier to Interferences and Noise Ratio (CINR) mean, CINR standard deviation, Received Signal Strength (RSS) mean, RSS standard deviation, timing adjustment, offset frequency adjustment, optimal transmission profile, and the like, and any combination thereof.

Group 2 comprises parameters whose values are derived from inter-frequency measurements carried out by inter-frequency measuring means on channels other than the estimated channel. Such optional parameters include: CQI, CINR mean, CINR standard deviation, RSSI mean, RSSI standard deviation, timing adjustment, offset frequency adjustment, optimal transmission profile, etc. and any combination thereof.

Group 3 comprises parameters whose values are derived from intersystem measurements carried out by intersystem measuring means. Such optional parameters include: current transmit power, maximum transmit power, power headroom, internal measurements on the equipment, etc. and any combination thereof.

Group 4 comprises parameters that relate to MS positioning measurements carried out by positioning measuring means. Examples of such parameters include: position indication using GPS or other triangular systems, time offset (propagation time), propagation loss, etc.

Group 5 comprises parameters that relate to measurements of the traffic volume carried out by traffic volume measuring means. Examples of such parameters include the amount of transmission units (bit, packet, burst of packets, frames, blocks, etc.) transmitted successfully/failed, for every link, connection, session, etc. existing or in holding between the managing and managed entities.

Group 6 comprises parameters that relate to measurements of the quality of the link carried out by link quality measuring means. Examples of such parameters include: Traffic Peak Rate/PIR with the time base for calculation, traffic rate deviation, latency, jitter, loss ratio, CIR fulfillment, voice quality, grade of service indications, BER, PER, BLER, network Key Performance Indicators (KPI), the amount of time the terminal received information in certain quality during a certain time period, information associated with connection switching, etc.

In one embodiment, the wake-up interval determination (WUID) module 154 is operative to optimize and update the wake-up interval access pattern in accordance with changes in subscriber profiles stored in memory so as to minimize the “idle value” (i.e. fewer wake-up intervals) while maintaining configured or provisioned constraints or requirements.

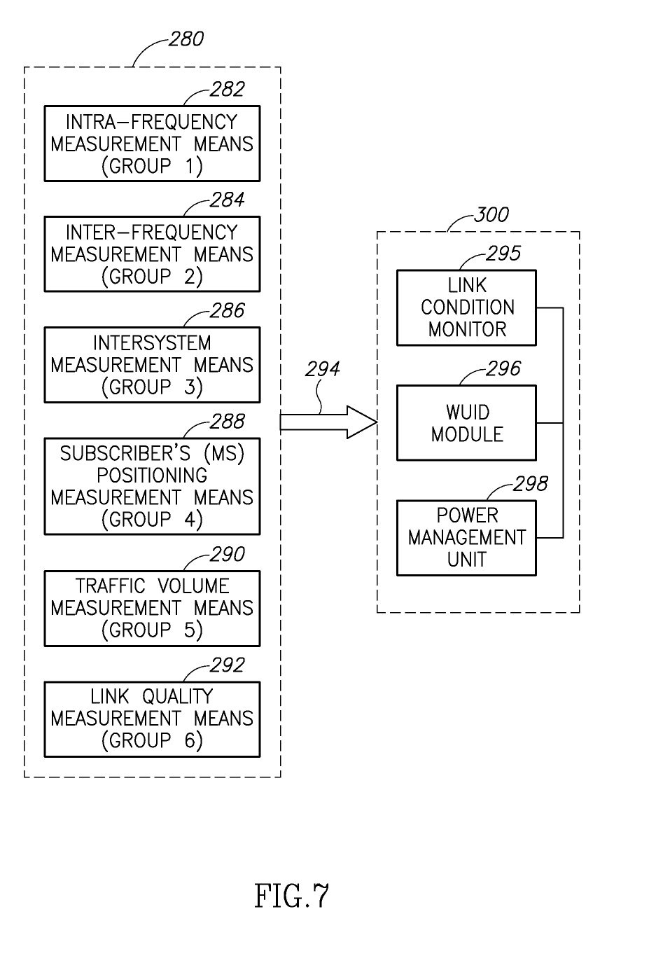

A diagram illustrating an example WUID module link parameter update mechanism is shown in FIG. 7. The example update mechanism comprises a block 280 of measurements comprising six groups of measurement types, namely Group 1 (282), Group 2 (284), Group 3 (286), Group 4 (288), Group 5 (290), Group 6 (292); and paging interval access block 300 comprising link condition monitor 295, WUID module 296 and power management unit 298.

The operation of the link condition monitor 295 is as described in connection with the link condition monitor 150 (FIG. 6). Similarly, the operation of the power management unit 298 is as described in connection with the PMU 156 (FIG. 6).

In operation, the link condition monitor collects measurement information, accumulates it and then sends any triggers to the WUID module 154. The PMU implements and/or manages the actual/selected wake-up interval access pattern.

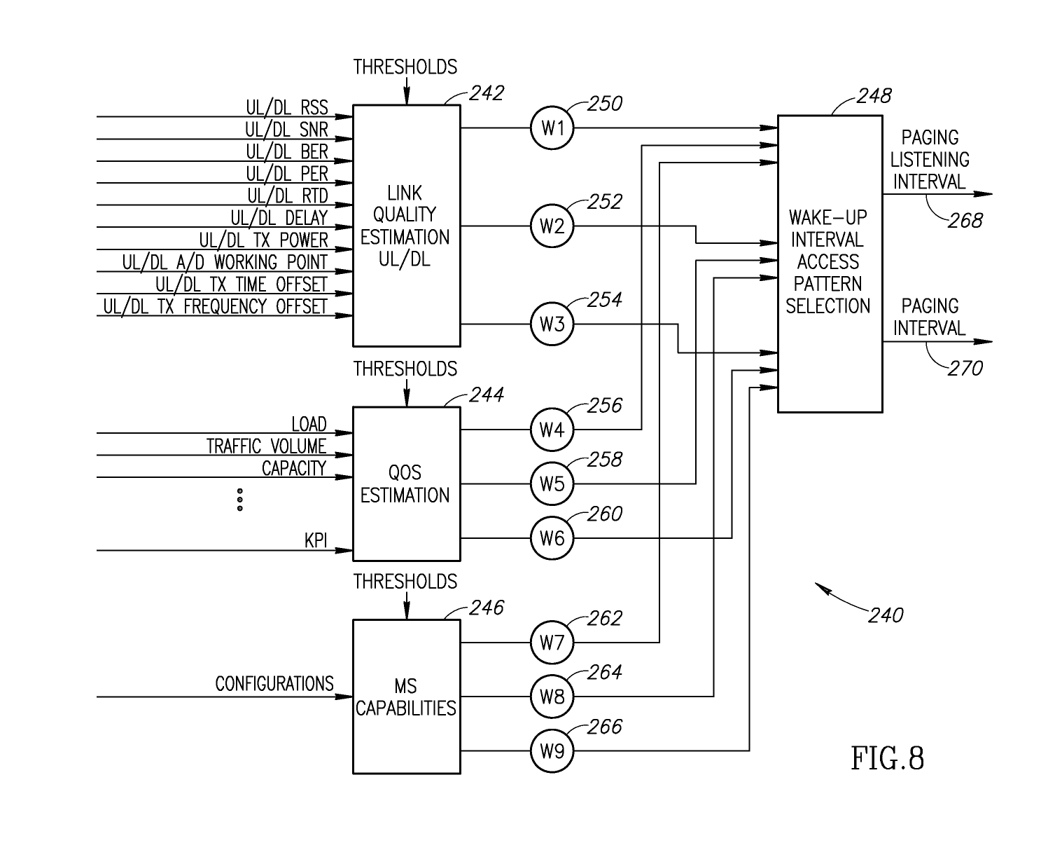

A diagram illustrating and example mechanism for wake-up interval access pattern selection is shown in FIG. 8. This block diagram shows an example process, generally referenced 240, of determining wake-up interval access pattern, namely the paging listening interval 268 and paging interval 270, which utilizes output from a link quality estimation block 242, QoS estimation block 244 and MS capabilities block 246 in its determination process.

The link quality estimation block 242 takes as input a plurality of UL and DL link quality related parameters such as RSS, SNR, PER, RTD, Delay, TX power, A/D working point, TX time offset, TX frequency offset, etc. as described supra. Based on one or more input thresholds, the block outputs estimates of the link quality between the MS and one or more base stations. Each of the link quality estimates is weighted via weights W1 250, W2 252, W3 254 before being input to the wake-up interval access pattern selection block 248.

The QoS estimation block 244 takes as input a plurality of UL and DL QoS related parameters such as Load, traffic volume, capabilities, KPI, etc. as described supra. Based on or more input thresholds, the block outputs QoS estimates of the link between the MS and one or more base stations. Each of the QoS estimates is weighted via weights W4 256, W5 258, W6 260 before being input to the wake-up interval access pattern selection block 248.

The MS capabilities block 246 takes as input a plurality of configuration information. Based on or more input thresholds, the block outputs capability information wherein each of the MS capability estimates is weighted via weights W7 262, W8 264, W9 266 before being input to the wake-up interval access pattern selection block 248.

In another embodiment, the WUID module generates wake-up interval access pattern “preferred idle values” which represent the frequency or pattern by which the MS should be woken in future paging cycles. Note that WUID module updates this value periodically or based on an event trigger. For example, the WUID module updates the preferred idle values (1) every wake-up interval or (2) based on a trigger sent by another MS component or module.

In one embodiment, the WUID module is operative to dynamically calculate or compute sets of wake-up intervals. Such a calculation or computation may be triggered periodically, a periodically or by a combination of both periodic and a periodic triggers, such as may occur, for example, when an MS currently in idle mode switches base stations and/or enters or exits a paging group. A periodic triggers may also occur when the MS currently in idle mode exits idle mode and enters active mode. Periodic triggers occur when the WUID module, link condition monitor module 150, processor 132 and/or any other component determines that sets of wake-up intervals need to be recalculated or updated.

Note that in an alternative embodiment, blocks 242, 244, 246 may be implemented by the link condition monitor block 150 (FIG. 6). The remaining blocks, including wake-up interval access pattern selection block 248, are implemented by the WUID 154 (FIG. 6). The outputs generated by the wake-up interval access pattern selection block 248 (i.e. paging listening interval 268 and paging interval 270) are forwarded to the PMU 156 (FIG. 6).

In accordance with an embodiment of the invention, the WUID module is operative to implement the wake-up interval access pattern adaptation algorithm. The adaptation algorithm can dynamically changes the idle ratio as a result of a change in the value of a single measurement performed by the link condition monitor module 150. Note that, preferably, such a measurement is selected from a group containing all or a portion of the measurements applied in the algorithm. The wake-up intervals access pattern is preferably set to the “maximal access pattern” based on predefined accuracy or availability level criteria, as indicated by the user. The estimation of the maximal access pattern is based on the results of some or all of the link quality measurements or other indications. The estimate, however, can change in accordance with the rate of change occurring in the air-interface channel.

Thus, higher quality air-interface links permit less frequent wake-up intervals (i.e. longer time duration or increased gaps between wake-up intervals). Conversely, lower quality air-interface links require more frequent wake-up intervals (i.e. shorter time duration or decreased gaps between wake-up intervals). In one embodiment, the MS would typically not increase the frequency of wake-up intervals beyond that originally configured by the BS or other control entity via “wake-up interval page configuration” data received in paging messages.

For example, if the air-interface channel characteristics remain constant or change relatively slowly, the wake-up interval access pattern value remains substantially constant. In accordance with the link quality measurement results, the WUID module assessment mechanism increases the time duration between wake-up intervals (i.e. the paging listening intervals access pattern). This can be achieved by simply skipping one or more wake-up intervals, e.g., waking up every other paging interval, every two paging intervals, every four intervals, or according to any other desired pattern. Note that an increase in the duration between wake-up intervals must still meet any minimum service availability requirements.

On the other hand, if the air-interface channel characteristics are not constant and change relatively quickly, the WUID module assessment mechanism decreases the time duration between consecutive wake-up intervals (i.e. the paging listening intervals access pattern).

The MS 130 also comprises a battery 157 operative to provide power to operate portions of the MS, such as the transceiver, processor, peripherals, memory, clocks, line condition monitor, idle processing module, WUID module and power management unit. At various times, the WUID module and/or other components may determine that it is desirable that the MS enter idle mode, such as based on (1) the current battery power level, (2) one or more link quality conditions (measurement results) reported by the line condition monitor, or (3) an elapsed time, which may be determined using clock module 144. Once the determination to enter idle is made, the WUID generates a request and/or message comprising information indicating that the MS is entering and/or modifying idle mode.

Note that during idle mode, the MS maintains frame synchronization (one of the few processes running during idle) using the power management unit 156. Further, the MS decodes downlink information periodically during wake-up intervals in order to check for a page from the BS. The power management unit is operative to execute and time this process based on the configuration determined by the WUID and/or other modules. The power management unit receives preferred idle values (i.e. wake-up access pattern) and executes the selected wake-up and unavailability intervals. The power management unit activates the MS during wake-up intervals in accordance with conventional techniques. In particular, the power management unit monitors the current time provided by clocks 144 and the MS 105 in accordance with the stored wake-up interval pattern. The power management unit determines the number of frames during which the MS is to be active or inactive (i.e. idle) based upon the preferred idle value. The power management unit also turns other internal components on and off accordingly.

The power management unit is also configured by the MS to execute an algorithm for a low power or sleep mode (without entering idle mode) to conserve power and to periodically activate the MS when appropriate. The algorithm may be implemented as one or more software applications or tasks executed in hardware, software or a combination of both. Alternatively, the algorithm may be a module that executes on the processor or other components separate from the power management unit.

The link condition monitor 150, idle processing module 152, wake-up interval determination module 154, power management unit 156 modules in the MS may be implemented in electronic circuitry hardware, software, microcode, firmware or any combination thereof. Depending on specific design constraints, the mechanism of the invention can be integrated into other entities in the MS or distributed across multiple entities.

The processor 132 comprises any conventional processor, such as a microprocessor, microcomputer, FPGA, ASIC or DSP core, capable of executing the software, microcode or firmware that implement the functions and operations described in connection with link condition monitor 150, idle processing module 152, wake-up interval determination module 154, power management unit 156 modules.

### Paging Access Availability Method

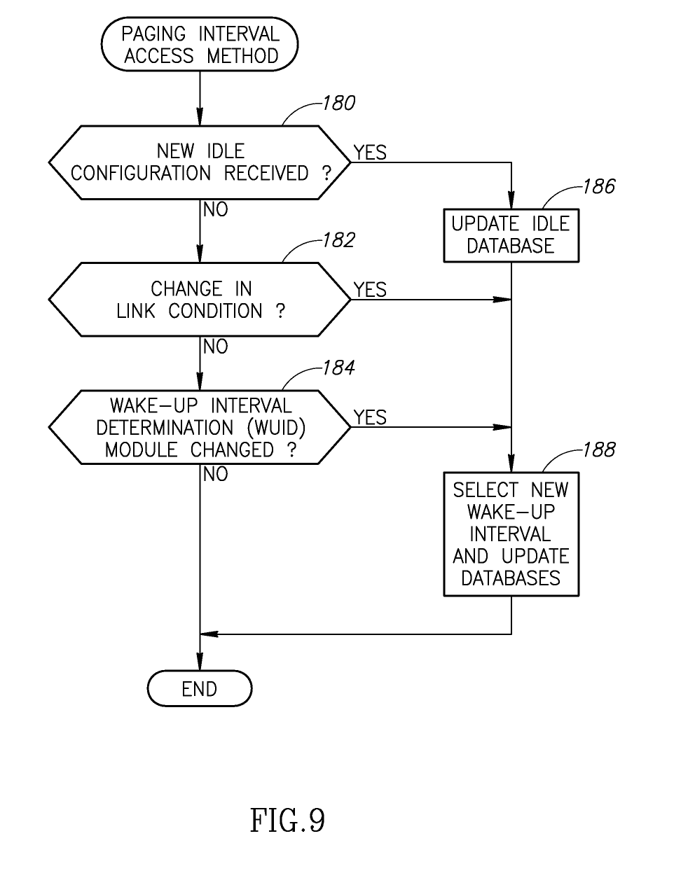

A flow diagram illustrating an example paging access availability method of the present invention is shown in FIG. 9. Note that this method may be executed more or less frequently depending on the parameters and requirements of the wireless communication system the MS is connected to.

With reference to FIGS. 6 and 8, if a paging message containing an idle configuration message and new idle configuration or changes to an idle configuration is received either from the BS 152 or the configuration interface 159 (step 180), than the idle database 148 is updated accordingly (step 186). A new paging access interval pattern including a new wake-up interval is either generated or selected from wake-up interval values determined a priori by the WUID and the wake-up interval database 146 is updated (step 188). For example, the wake-up interval information is stored in a look up table (LUT) indexed by one or more link quality parameters.

If a change in link condition is detected (i.e. link quality measurement results have changed) by the link condition monitor module 150 (step 182), a new wake-up interval is either generated by the WUID or selected from wake-up interval values determined a priori by the WUID and the wake-up interval database 146 is updated (step 188).

If the WUID module is activated by or detects a change in other modules in the MS (step 184), than a new wake-up interval is either generated or selected from wake-up interval values determined a priori and the wake-up interval database 146 is updated (step 188).

In step 188, the WUID module determines a preferred idle wake-up pattern values for the MS based upon the subscriber's profile, link quality condition and/or other configurations. As described supra, preferred idle values (i.e. wake-up intervals) may be determined for each of a plurality of time periods. The WUID module then compares the subscriber's preferred sleep values with their idle values stored in memory. If an update is needed, the WUID module updates the wake-up interval and idle databases with the new idle values.

It is noted that many modern wireless communication protocols now have the capability of engaging in two-way messaging, thereby enabling notification and negotiation with the BS of MS selected paging access availability cycles and idle configuration parameters such as “idle values”.

### Wake-Up Interval Determination Method

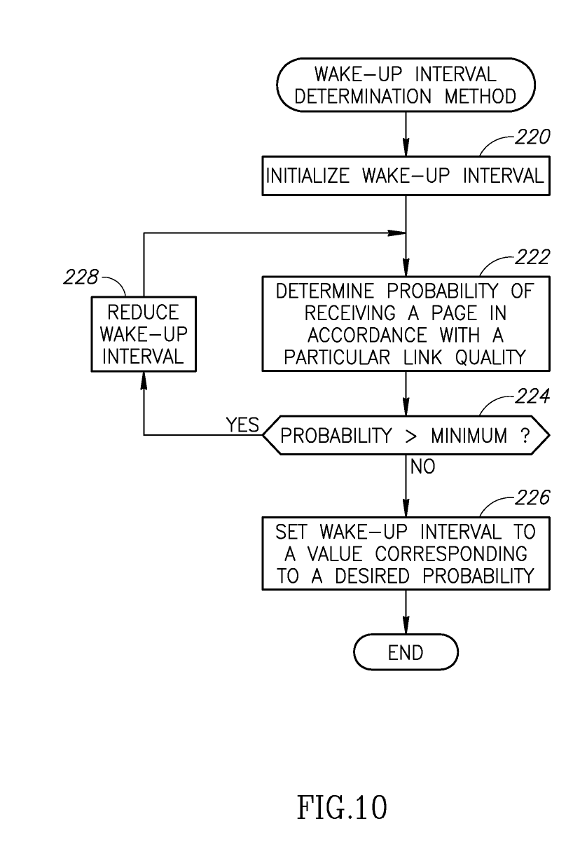

A flow diagram illustrating the wake-up interval determination method of the present invention is shown in FIG. 10. This method is provided as an example algorithm that can be used by the WUID module to calculate wake-up intervals. Depending on the implementation, a plurality of wake-up intervals can be calculated a priori as a function of link quality and stored in a wake-up interval table. During operation of the MS, the WUID module uses the results of link quality measurements to update the paging listening intervals access pattern. Depending on the link quality measurement results, the MS may skip one or more wake-up intervals.

To determine the wake-up interval, the wake-up interval value is set to an initial value (for example, paging listening interval and paging interval) (step 220). The initial value may, for example, we set to the value configured by the BS. The probability of receiving a page as a function of a particular link quality based in the initial value is calculated (step 222). The probability typically corresponds to a minimum required paging availability or probability of service re-establishment, e.g., 99.99%.

The first step in calculating the probability of receiving a page message as a function of a particular link quality is to calculate the probability of receiving a paging massage in a single listening interval (P_{r,si}). The probability (P_{r,si}) can be calculated (1) based on the link condition indication, (2) using an offline simulation, or (3) based on learning the actual paging massage receive ratio.

The paging availability, i.e. service reestablishment, is calculated by considering the probability of receiving a paging message within a single paging cycle based on the number of receive opportunities (i.e. the number of paging listening intervals in one paging cycle. The method is based on the well known conditional probability, written as P(A|B) and expressed as the probability of A, given B.

$$P ( A \vert B ) = \frac{P ( A , B )}{P ( B )} \qquad ( 1 )$$

where P(A,B) is the joint probability of A and B.

Next, the single listening paging interval is eliminated from the paging cycle (228). The listening paging interval to be eliminated is selected in accordance with an algorithm. The algorithm is based on one or more link condition indications, using an offline simulation that indicates which listening interval to eliminate. The probability of receiving a page is then recalculated. Note that this portion of the method (step 222) may be repeated for many of the different possible link quality parameters.

If the probability is greater than a predetermined minimum (step 224), then the wake-up interval value is reduced (i.e. fewer wake-up periods meaning a longer time duration between wake-up intervals) (step 228) and the probability is calculated again with the smaller wake-up value (step 222). Eventually, the wake-up interval value will be reduced to a point where the minimum required probability is not met. The wake-up interval value is then set to a value corresponding to a value that just meets the minimum requirements (i.e. paging availability/service reestablishment) and stored in the wake-up interval table indexed by the particular link quality. This method can be repeated to generate a plurality of wake-up values for various link quality parameter values.

### Computer Processing System

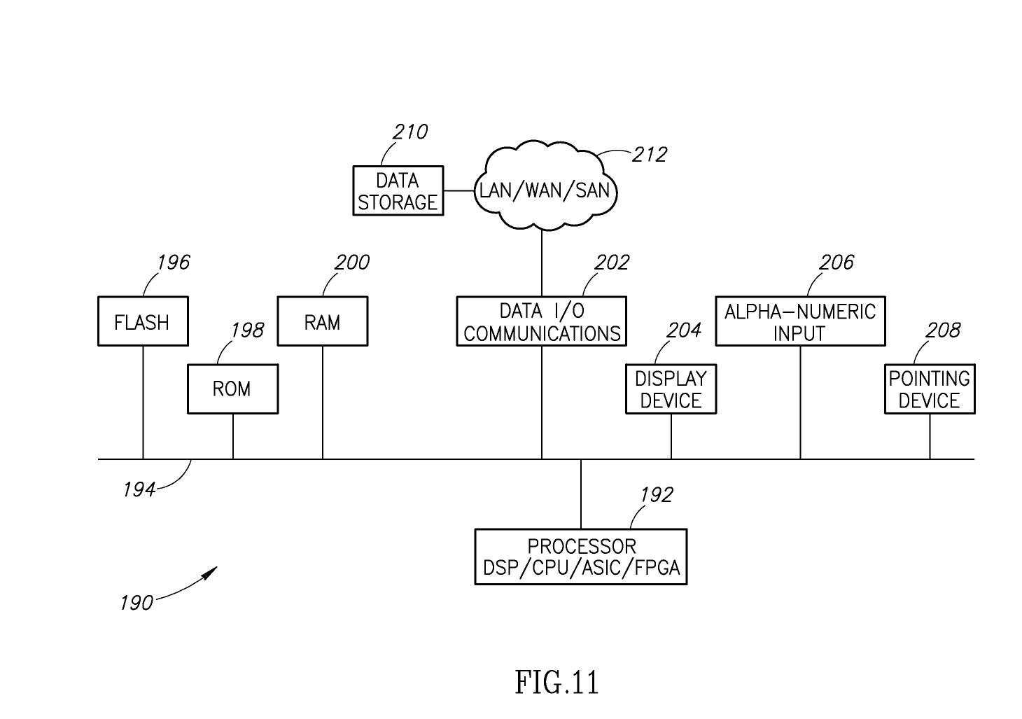

A block diagram illustrating an example computer processing system adapted to implement the paging access availability mechanism of the present invention is shown in FIG. 11. The computer system, generally referenced 190, comprises a processor 192 which may comprise a digital signal processor (DSP), central processing unit (CPU), microcontroller, microprocessor, microcomputer, ASIC, FPGA or DSP core, etc.

The system also comprises static read only memory 198 and dynamic main memory 200 all in communication with the processor. The processor is also in communication, via bus 194, with a number of peripheral devices that are also included in the computer system. Peripheral devices coupled to the bus include a display device 204 (e.g., monitor), alpha-numeric input device 206 (e.g., keyboard) and pointing device 208 (e.g., mouse, tablet, etc.)

The computer system is connected to one or more external networks such as either a LAN, WAN or SAN 212 via communication lines connected to the system via data I/O communications interface 202 (e.g., network interface card or NIC). The network adapters 202 coupled to the system enable the data processing system to become coupled to other data processing systems or remote printers or storage devices through intervening private or public networks. Modems, cable modem and Ethernet cards are just a few of the currently available types of network adapters. The system also comprises magnetic or semiconductor based storage device 210 for storing application programs and data. The system comprises computer readable storage medium that may include any suitable memory means, including but not limited to, magnetic storage, optical storage, semiconductor volatile or non-volatile memory, biological memory devices, or any other memory storage device.

Software adapted to implement the paging access availability management mechanism of the present invention is adapted to reside on a computer readable medium, such as a magnetic disk within a disk drive unit. Alternatively, the computer readable medium may comprise registers, a CD-ROM, floppy disk, RAM memory, flash memory, hard disk, removable hard disk, Flash memory 196, EPROM, EEPROM, EEROM based memory, solid state memory, registers, bubble memory storage, ROM memory, distribution media, intermediate storage media, execution memory of a computer, and any other medium or device capable of storing for later reading by a computer a computer program implementing the mechanism of this invention. The software adapted to implement the paging access availability management mechanism of the present invention may also reside, in whole or in part, in the static or dynamic main memories or in firmware within the processor of the computer system (i.e. within microcontroller, microprocessor or microcomputer internal memory).

Other digital computer system configurations can also be employed to implement the paging access availability management mechanism of the present invention, and to the extent that a particular system configuration is capable of implementing the system and methods of this invention, it is equivalent to the representative digital computer system of FIG. 11 and within the spirit and scope of this invention.

Once they are programmed to perform particular functions pursuant to instructions from program software that implements the system and methods of this invention, such digital computer systems in effect become special purpose computers particular to the method of this invention. The techniques necessary for this are well-known to those skilled in the art of computer systems.

It is noted that computer programs implementing the system and methods of this invention will commonly be distributed to users on a distribution medium such as floppy disk or CD-ROM or may be downloaded over a network such as the Internet using FTP, HTTP, or other suitable protocols. From there, they will often be copied to a hard disk or a similar intermediate storage medium. When the programs are to be run, they will be loaded either from their distribution medium or their intermediate storage medium into the execution memory of the computer, configuring the computer to act in accordance with the method of this invention. All these operations are well-known to those skilled in the art of computer systems.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method of paging access availability management in a mobile station, said method comprising the steps of:
determining a current operating condition of said mobile station; and
determining a dynamic wake-up interval access pattern based on said current operating condition.

2. The method according to claim 1, wherein said wake-up interval access pattern is updated based on an event trigger.

3. The method according to claim 1, wherein said wake-up interval access pattern is updated periodically.

4. The method according to claim 1, wherein said wake-up interval access pattern is selected from a plurality of wake-up intervals computed a priori.

5. The method according to claim 1, wherein said wake-up interval access pattern is selected so as to reduce power consumption while maintaining a desired level of service availability.

6. The method according to claim 1, wherein said wake-up interval access pattern is chosen based on a predefined accuracy so as to minimize the number of active wake-up intervals while maintaining a desired level of service availability.

7. The method according to claim 1, wherein said wake-up interval access pattern is chosen based on one or more availability level criteria so as to minimize the number of active wake-up intervals while maintaining a desired level of service availability.

8. The method according to claim 1, wherein said wake-up interval access pattern is chosen to achieve maximal paging interval access based on the results of one or more link quality measurements.

9. The method according to claim 1, wherein gaps between wake-up intervals increase if channel characteristics improve.

10. The method according to claim 1, wherein gaps between wake-up intervals decrease if channel characteristics deteriorate.

11. The method according to claim 1, wherein said step of determining said wake-up interval access pattern comprises the steps of:
initializing a wake-up interval value; and
decreasing said wake-up interval value until a desired minimum probability of mobile station paging availability is attained.

12. A method of paging access availability management in a mobile station, said method comprising the steps of:
receiving an idle configuration from a base station and determining a paging listening intervals access pattern therefrom;
determining a current operating environment of said mobile station; and
skipping one or more wake-up intervals of said paging listening intervals access pattern based on said current operating environment.

13. The method according to claim 12, wherein wake-up interval information is stored in a look up table (LUT) indexed by one or more link quality parameters.

14. The method according to claim 12, further comprising the step of reassessing at each wake-up interval said paging listening intervals access pattern and any skipped wake-up intervals.

15. The method according to claim 12, further comprising the step of reassessing upon a change in idle configuration said paging listening intervals access pattern and any skipped wake-up intervals.

16. The method according to claim 12, further comprising the step of reassessing upon a change in said current operating condition said paging listening intervals access pattern and any skipped wake-up intervals.

17. A mobile station, comprising:
a receiver operative to receive paging messages;
an idle processor operative to process said paging messages and determine a paging listening intervals access pattern therefrom;
a link condition monitor operative to determine one or more link quality measurements; and
a wake-up interval module operative to modify said paging listening intervals access pattern based on said one or more link quality measurements.

18. The mobile station according to claim 17, wherein a modification to said paging listening intervals access pattern comprises skipping one or more wake-up intervals.

19. The mobile station according to claim 17, wherein said paging listening intervals access pattern is chosen based on a predefined accuracy so as to minimize the number of active wake-up intervals while maintaining a desired level of service availability.

20. The mobile station according to claim 17, wherein said paging listening intervals access pattern is chosen based on one or more availability level criteria so as to minimize the number of active wake-up intervals while maintaining a desired level of service availability.

21. The mobile station according to claim 17, wherein said paging listening intervals access pattern is chosen to achieve maximal paging interval access based on the results of one or more link quality measurements.

22. A mobile station, comprising:
a receiver operative to receive paging messages over a paging channel;
an idle module operative to process said paging messages, identify a wake-up interval page configuration and update a wake-up interval table;
a link condition monitor operative to determine current link conditions; and
a wake-up module operative to determine a paging listening intervals access pattern using said wake-up interval table whereby said receiver skips one or more wake-up intervals based on said current link conditions.

23. The mobile station according to claim 22, wherein said paging listening intervals access pattern is chosen to achieve maximal paging interval access based on a predefined accuracy.

24. The mobile station according to claim 22, wherein said paging listening intervals access pattern is chosen based on one or more availability level criteria so as to minimize the number of active wake-up intervals while maintaining a desired level of service availability.

25. The mobile station according to claim 22, wherein said paging listening intervals access pattern is chosen based on the results of one or more link quality measurements so as to minimize the number of active wake-up intervals while maintaining a desired level of service availability.

26. A computer readable storage medium having computer readable program code stored therein for execution by a processor to perform paging access availability management on a mobile station, the computer readable program code comprising:
computer readable program code that processes received paging messages, identifies a wake-up interval page configuration and updates a wake-up interval table;
computer readable program code that determines current wireless link conditions;
computer readable program code that determines a paging listening intervals access pattern utilizing said wake-up interval table whereby one or more wake-up intervals is skipped based on said current link conditions.
